(19) United States
(12) Patent Application Publication
(10) Pub. No.: US 2025/0125857 A1
(43) Pub. Date: Apr. 17, 2025

(54) METHOD AND SYSTEM FOR BEAM INDICATION IN WIRELESS NETWORK

(71) Applicant: ZTE Corporation, Shenzhen (CN)

(72) Inventors: Shuang ZHENG, Shenzhen (CN); Nan ZHANG, Shenzhen (CN); Wei CAO, Shenzhen (CN); Hanqing XU, Shenzhen (CN); Ziyang LI, Shenzhen (CN)

(21) Appl. No.: 18/989,949

(22) Filed: Dec. 20, 2024

Related U.S. Application Data
(63) Continuation of application No. PCT/CN2022/111819, filed on Aug. 11, 2022.

(51) Int. Cl. H04B 7/06

(52) U.S. Cl. CPC H04B 7/06952

(57) ABSTRACT

Methods and systems for techniques for indicating beam information that can be used on access links, backhaul links, and control links are disclosed. In an implementation, a method of wireless communication includes receiving a beam indication for access links comprising at least one of a first forwarding link from a network node to a wireless communication device, or a second forwarding link from the wireless communication device to the network node, receiving a beam indication for backhaul links comprising at least one of a third forwarding link from a wireless communication node to the network node, or a fourth forwarding link from the network node to the wireless communication node, and receiving a beam indication for control links comprising at least one of a first control link from the wireless communication node to a network node, or a second control link from the network node to the communication node.

### CROSS REFERENCE TO RELATED APPLICATIONS

This patent document is a continuation of and claims benefit of priority to International Patent Application No. PCT/CN2022/111819, filed on Aug. 11, 2022. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for indicating beam information that can be used on access links, backhaul links, and control links.

In one aspect, a method of data communication is disclosed. The method includes receiving, by a network node, a beam indication for access links from a wireless communication node, the access links comprising at least one of a first forwarding link from the network node to a wireless communication device, or a second forwarding link from the wireless communication device to the network node, and performing a communication using at least one of the access links. The method may further include receiving, by the network node, a beam indication for backhaul links from the wireless communication node, the backhaul links comprising at least one of a third forwarding link from the wireless communication node to the network node, or a fourth forwarding link from the network node to the wireless communication node, and performing a communication using at least one of the backhaul links. The method may further include receiving, by the network node, a beam indication for control links from the wireless communication node, the control links comprising at least one of a first control link from the wireless communication node to a network node, or a second control link from the network node to the communication node, and performing a communication using at least one of the control links.

In another aspect, a method of data communication is disclosed. The method includes receiving, by a network node, from a wireless communication node, a configuration information that indicates information associated with a number of beams configured for the network node on access links.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of a network controlled repeater.

FIG. 4 shows an example of a unified numbering mechanism for beams of NCR on access links based on some implementations of the disclosed technology.

FIG. 5 shows an example of a group numbering mechanism for beams of NCR on the access link based on some implementations of the disclosed technology.

FIG. 6 shows example indices for wider beam and narrow beam based on some implementations of the disclosed technology.

FIG. 7 shows examples of separate numbering mechanism for beams of access links based on some implementations of the disclosed technology.

FIG. 8 shows an example list of beam patterns based on some implementations of the disclosed technology.

FIG. 9 shows an example of an ordered sequence of beam IDs based on some implementations of the disclosed technology.

FIG. 10 shows an example of a process for wireless communication based on some example embodiments of the disclosed technology.

FIG. 11 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

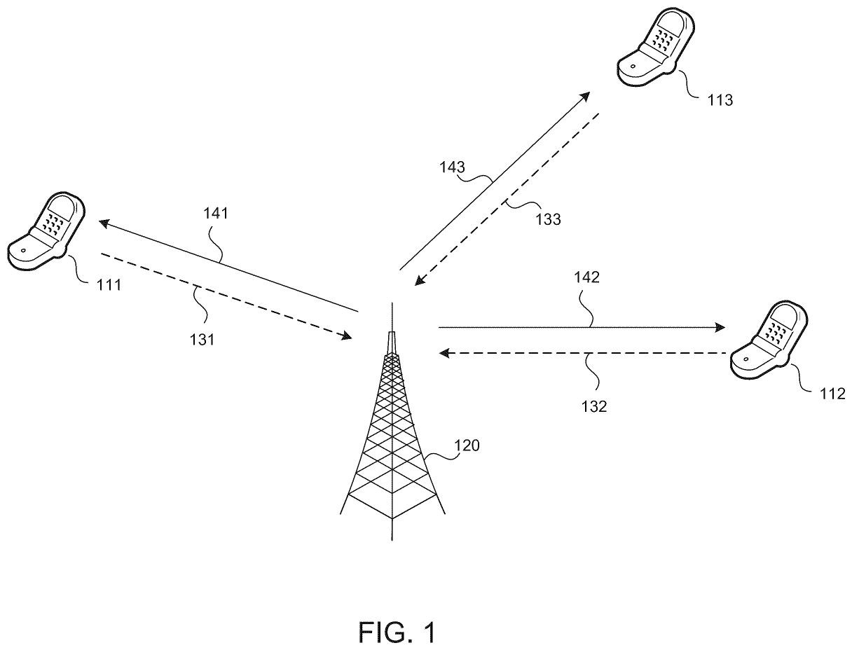

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

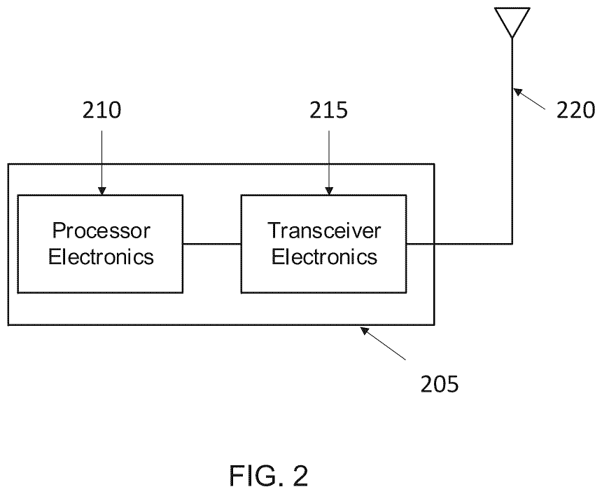

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

As the new radio (NR) system moves to higher frequencies (around 4 GHz for FR1 deployments and above 24 GHz for FR2), propagation conditions degrade compared to lower frequencies exacerbating the coverage challenges. As a result, further densification of cells may be necessary. While the deployment of regular full-stack cells is preferred, it may not be always a possible (e.g., not availability of backhaul) or economically viable option. To provide blanket coverage in cellular network deployments with relatively low cost, RF repeaters with full-duplex amplify-and-forward operation have been used in 2G, 3G and 4G systems. However, the major problem brought by the RF repeater is that it amplifies both signal and noise and increases interference in the system.

In addition, the NR systems use multi-beam operations with associated beam management in the higher frequency bands defined for time division duplex (TDD). The multi-antenna techniques consisting of massive multiple input multiple output (MIMO) for Frequency Range 1 (FR1) and analog beamforming for Frequency Range 2 (FR2) assist in coping with the challenging propagation conditions of these higher frequency bands. The RF repeater without beam management functions may not provide beamforming gain in its signal forwarding.

To cope with the unwanted interference, a smart node can be considered, which makes use of the control information from its connected BS to enable an intelligent amplify-and-forward operation.

The disclosed technology can be implemented in some embodiments to provide beam information indication for a cellular network with the smart nodes.

### RF Repeater

Radio frequency (RF) repeaters have been used in 2G, 3G and 4G deployments to supplement the coverage provided by regular full-stack cells with various transmission power characteristics. They constitute the simplest and most cost-effective way to improve network coverage. The main advantages of RF repeaters are their low-cost, their ease of deployment and the fact that they do not increase latency. The main disadvantage is that they amplify signal and noise and, hence, may contribute to an increase of interference (pollution) in the system. Within RF repeaters, there are different categories depending on the power characteristics and the amount of spectrum that they are configured to amplify (e.g., single band, multi-band, etc.). RF repeaters are non-regenerative type of relay nodes and they simply amplify-and-forward signal in an omnidirectional way.

### Network Controlled Repeater (NCR)

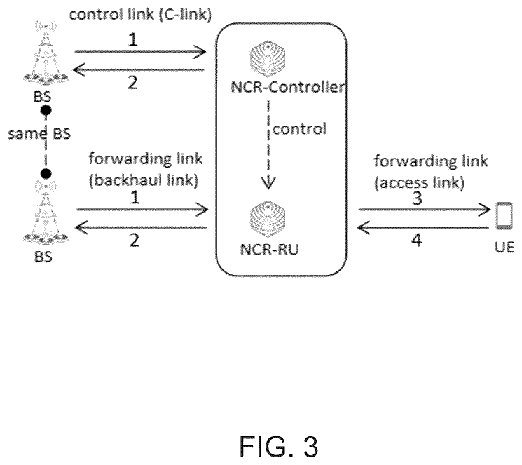

FIG. 3 shows an example of a network controlled repeater.

From functionality perspective, the general structure of the NCR is provided in FIG. 3.

The NCR-Controller maintains Control link (C-link) between Base Station (BS) and NCR to enable the information exchanges, e.g., carrying the side control information.

The NCR-RU (Radio Unit) uses Forwarding link (F-link), which can be referred to as F-link for backhaul (e.g., F-link 1&2) and F-link for access (e.g., F-link 3&4), to forward data between BS and UE(s). The behavior of F-link will be controlled according to the received side control information from BS.

The NCR needs to indicate the beam information used on F-links to NCR. The beam information used on F-links includes the beam for the access link (e.g., F-link 3&4) and the beam for the backhaul link (e.g., F-link 1&2).

### Embodiment 1: Beam Information for Access Link

In some implementations of the disclosed technology, logical beam indices/IDs can be used to directly indicate the beam information for the access link. The NCR needs to report its beamforming capability information to the BS or the BS can receive the beamforming capability information form the OAM. The capability information of NCR includes at least one of: the number of NCR's beams, the indices/IDs of NCR's beam, the width of NCR's beams, the direction of NCR's beams, the location of NCR, or the type of NCR's beams. Here, the type of NCR's beams can refer to different width of NCR's beams, or it can refer to the fixed beams or adaptive beams. In addition, the granularity of beamforming capability information can be per link or per NCR, which means the BS can receive the different beamforming capability information of different NCRs, or the BS can receive the beamforming capability information of different links for NCR, and the links can refer to at least one of the access links, backhaul links or control links. The capability information discussed above can be directly sent to the BS by NCRs or by operations administration and maintenance units (OAMs). After receiving the capability information of the NCR, the BS can configure the number of NCR's beams used on the access link and the corresponding logical beam indices to the NCR.

Case 1: the BS can directly indicate the NCR's beam index for the access link to the NCR. In some implementations of the disclosed technology, the detailed indication information includes following options:

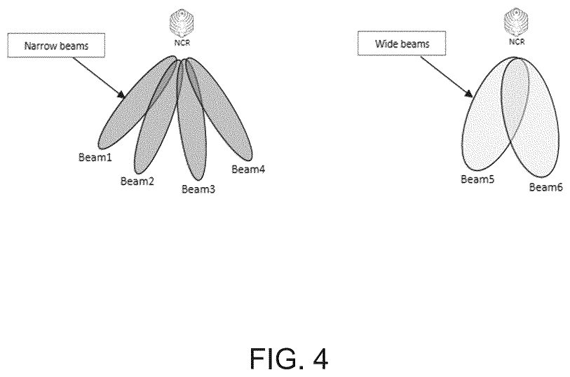

FIG. 4 shows an example of a unified numbering mechanism for beams of NCR on access links based on some implementations of the disclosed technology.

Option 1: the BS can have a unified number for all the NCR's beams (including wide beams and narrow beams) used on the access link. For example, as shown in FIG. 4, the NCR can support a maximum of M (e.g., M=5) beams on the access link, there are 4 narrow beams and 2 wide beams of access links for NCR, and these 6 beams can be uniformly numbered from beam 1 to beam 6. In this case, the gNB can directly indicate the beam using the corresponding beam index.

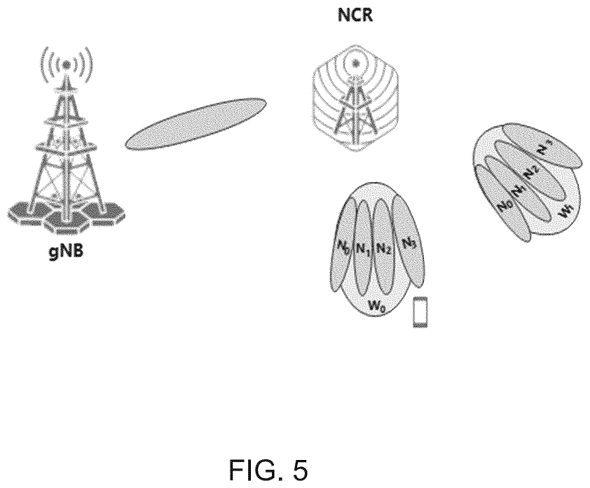

FIG. 5 shows an example of a group numbering mechanism for beams of NCR on the access link based on some implementations of the disclosed technology.

In other implementations, a group indication mechanism can be used for the BS to indicate the beam information of the access link to save the signaling cost. For example, the NCR's beams supported on the access link can distinguish the narrow beam and wider beam. As shown in FIG. 5, there are X (X=2 in this example, W0 and W1 are wide beams) wider beams at NCR's access link, and each wider beam includes Y (Y=4 in this example, N0, N1, N2, N3 are narrow beams) narrow beams. In this case, different methods can be used to indicate the beam indices, as will be discussed below.

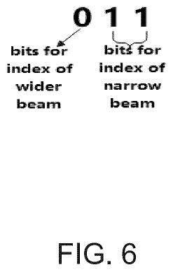

FIG. 6 shows example indices for wider beam and narrow beam based on some implementations of the disclosed technology.

Option 2: the index of the wider beam and the index of the narrow beam can be indicated together using a same signaling. In some implementations, the content of the signaling may include two parts: (1) a part of consecutive bits can be used to indicate the index of wider beam, (2) the other part of consecutive bits can be used to indicate the index of narrow beam. For example, the first [log₂^{X}] bits (1 bit in this example) can be used to indicate the belonged wider beam. The last [log₂^{Y}] bits (2 bits in this example) can be used to indicate the index of narrow beam in the belonged wider beam group. As shown in FIG. 5, when a UE is under the forwarding narrow beam N₃ of NCR, and the BS wants to indicate the narrow beam N₃ of the wider beam W₀ to the NCR for the access link, the bits indication information from the BS to the NCR can be 011, where the first bit represents the index of wider beam (here “0” represents the wider beam W₀, “1” represents the wider beam W₁), the last two bits represent the index of the narrow beam of the selected wider beam.

Option 3: in order to further save the signaling cost, the index of the wider beam and the narrow beam can be indicated separately using different signaling patterns or techniques. For example, the BS can indicate the index of wider beam first, and then use another signaling to indicate the index of narrow beam. The NCR can determine the beam after receiving these two pieces of information. In this case, if the wider beam index for the access link does not change, the BS can only indicate the index of narrow beam to the NCR to save the signaling cost. If the wider beam changes, the BS can reconfigure the index of wider beam to update the index of wider beam to the NCR. For example, in the first beam indication for the access link as shown in FIG. 5, the BS can use one bit to configure the beam index of wider beam (e.g., bit “0” indicates the wider beam W0), then use 2 bits to configure the beam index of narrow beam (e.g., bits “01” indicate the narrow beam N1 in the wider beam W0). In addition, if the indicated wider beam information can stay valid until the NCR receives the next new configuration from the BS, then the BS can only use two bits to indicate the updated narrow beam index to save the signaling overhead.

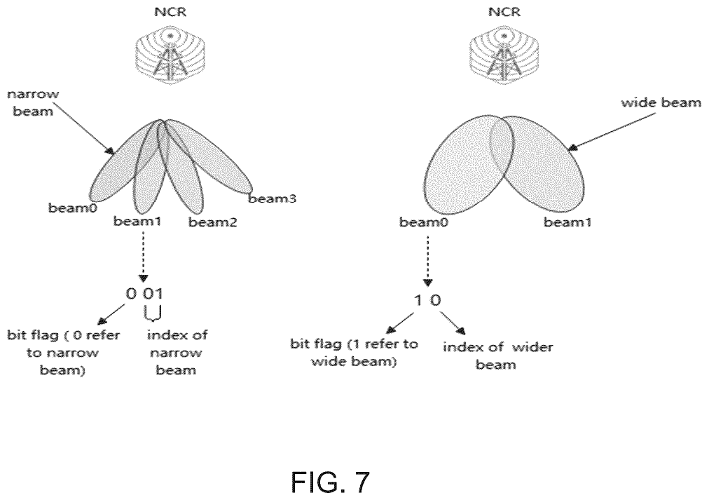

FIG. 7 shows examples of separate numbering mechanism for beams of access links based on some implementations of the disclosed technology.

Option 4: different numbering for wide beams and narrow beams on access links for NCR can be considered. All the wide beams can be numbered one by one, and all the narrow beams can be numbered one by one. The index of the wider beam and the narrow beam can be indicated using the same signaling, and in order to differentiate the beam indication between the wider beam or the narrow beam, a bit flag can be used in the beam information indication (e.g., the first bit in the beam indication) to differentiate the bit information between the wider beam and the narrow beam. Thus, in the beam information indication, one bit of a plurality of bits can be used to indicate whether a certain beam is a wider beam or a narrow beam, and the remaining bits of the plurality of bits can be used to indicate the beam index of the corresponding wider beam and/or narrow beam. For example, as shown in FIG. 7, at first the BS wants to indicate the wider beam W0 shown in FIG. 5 to the NCR, the 2 wide beams of NCR can be numbered from beam 0 to beam 1, while the narrow beams of NCR can be numbered from beam 0 to beam 3. In this case, a bit (e.g., the first bit in the bit information) can be used to indicate whether the indication index is for wide beams or narrow beams. The BS can indicate “10” to the NCR, where the first bit is a bit flag, and since there are only two wider beams in FIG. 7, thus the last one bit is sufficient to indicate that it is the beam index of wider beam. In addition, the BS wants to indicate the narrow beam 1 shown in FIG. 7 to the NCR, the BS can indicate “001” to the NCR, where the first bit is a bit flag and since there are four narrow beams, the last two bits indicate that it is the beam index of the narrow beam.

Case 2: the SSB/CSI-RS index can be directly used to indicate the beam for the access link.

During the beam sweeping stage, the NCR-RU needs to transmit the different ssb/csi-rs (synchronization signal block/channel state information reference signal) using different beams of NCR-RU to UEs. Since the number of beams of NCR-RU needs to be indicated to the BS, a set of reference signals (e.g., SSB, CSI-RS, SRS, DMRS) index can be one-to-one mapped to the forwarding beams of NCR-RU for the access link. For example, there are four forwarding beams 1-4 on the access link, and the SSBs can be used to be one-to-one mapped to the forwarding beams:

{SSB1 is mapped to beam #1, SSB2 is mapped to beam #2, SSB3 is mapped to beam #3, SSB4 is mapped to beam #4}

In addition, the mapping relationship between the ssb/csi-rs index and the corresponding beam index of NCR-RU for the access link are indicated to NCR by the BS. In this case, when the BS wants to indicate the beam information of the access link, the BS can directly indicate the ssb/csi-rs index to the NCR according to the received mapping relationship. Then, the NCR can control the NCR-RU to transmit/receive the signal using the corresponding beam based on the mapping relationship. In addition, if there are different widths of beams for NCR on access links (e.g., the wide beams and narrow beams), and each wide beam can include multiple narrow beams, and different types of reference signals are mapped to different widths of beams. In this case, the QCL relationship of reference signals used for the narrow beams can refer to the reference signal used for the belonged wide beam. For example, different SSB IDs (SSB1 is mapped to wide beam 1, SSB2 is mapped to wide beam 2) are mapped to the wide beams of NCR's access links, and different CSI-RS IDs are mapped to the narrow beams of NCR's access links (as for the group of wide beam 1, CSI-RS 1 is mapped to narrow beam 1, CSI-RS2 is mapped to narrow beam 2; as for the group of wide beam 2, CSI-RS 3 is mapped to narrow beam 3, CSI-RS4 is mapped to narrow beam 4). Thus, the QCL relationship of CSI-RS1 and CSI-RS2 can refer to the corresponding SSB1, and the QCL relationship of CSI-RS3 and CSI-RS4 can refer to the SSB2.

### Embodiment 2: Beam Information for the Backhaul Link

Since the control link and backhaul link of NCR share the same communication condition, the following options can be considered for the beam indication of the backhaul link.

Option 1: if the BS configures the beam information for the control link of NCR, the beam information of the backhaul link can be the same as the beam information of the control link. In this case, once there exists the beam indication for the control link, the beam information for the backhaul link can directly follow the control link.

However, there may exist a possibility that the NCR-controller operates in the sleep mode or cannot work well for some reason. In this case, there are not beam indications for the control link. Thus, the beam information for the backhaul link can be considered.

Option 2: the beam information for the backhaul link can still follow the legacy beam information configured for the control link. Considering the stationary deployment of NCR, the communication condition does not change frequently, and thus the beam information may not change. In this case, the legacy configured beam information for the control link can be still reused for the backhaul link when the NCR-controller does not work.

Option 3: additional indication can be configured by the BS to indicate the beam information for the backhaul link. Therefore, when the NCR-controller operates in the sleep mode or cannot work well for some reason, the BS can use the additional signaling dedicated for the backhaul link to indicate the beam information, or a new signaling can be defined from the BS to determine that the indicated TCI state is for the beam information of the backhaul link.

Option 4: As for the beams of NCR on backhaul link, the beam indication mechanism for the access links described in embodiment 1 can also applicable to the backhaul link. In some implementations, the beam indication for the backhaul links can directly use the beam index, and different numbering options shown in embodiment 1 can be applied to the backhaul links, or the mapping relationship can be defined between the reference signals IDs and the beam index of backhaul links.

### Embodiment 3: Beam Indication for the Access Link

In some implementations of the disclosed technology, a list of beam pattern can be used to indicate the beam information for the access link of NCR. Following two cases can be considered.

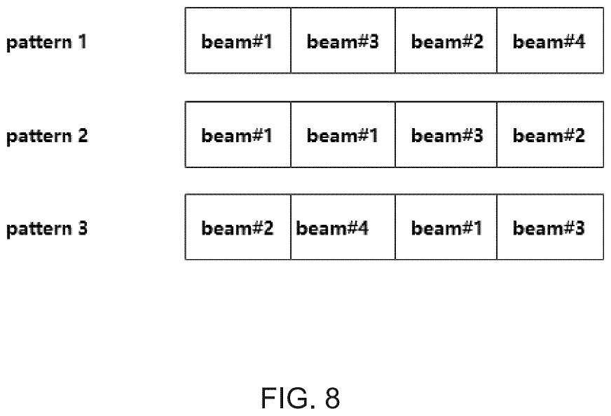

FIG. 8 shows an example list of beam patterns based on some implementations of the disclosed technology.

Case 1: a list of beam patterns can be configured by the BS (e.g., configured by the Radio Resource Control (RRC) or Medium Access Control (MAC) Control Element (MAC CE)), where each beam pattern is an ordered sequence of beams to be used one by one. In this case, the BS can directly indicate the beam pattern ID to the NCR, e.g., using the DCI to indicate the beam pattern ID. Here, the beam information of each beam in the beam pattern can be the beam index, the source RS ID, or the TCI state ID. For example, the NCR has 4 beams, and the BS can configure a list including 3 beam patterns as shown in FIG. 8. Thus, if the BS wants to configure the beam pattern 3 to the NCR, the BS can directly use bit “10” to indicate the beam information to the NCR. In addition, the signaling of beam information can be indicated via the RRC, MAC CE or DCI by the BS.

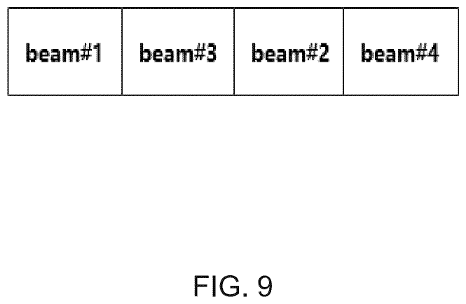

FIG. 9 shows an example of an ordered sequence of beam IDs based on some implementations of the disclosed technology.

Case 2: the BS can directly indicate an ordered sequence of beam IDs to be used one by one to the NCR, e.g., using the field of DCI. Here, the beam ID of each beam can be the beam index, the source RS ID, or the TCI state ID. Also, the signaling of beam information can be indicated via the RRC, MAC CE or DCI.

As for the applicable time information of the above two cases, following options can be considered.

Option 1: no explicit time indication, which means that the default time length is used for each beam. In addition, the default time length can be a slot, a symbol, a predetermined number of slots, or a predetermined number of symbols. In this case, if different time granularity of time length for each beam in the beam pattern is considered (e.g., slot level granularity is needed in the beam training stage and the symbol level granularity in the data transmission stage), a flag can be defined to indicate the time granularity is slot or symbol.

Option 2: explicit indication, where a time length indication can be used and indicated to the NCR with the corresponding indicated beam information, and this time length is applicable to all beams. Also, the granularity of the time length can be slots or symbols. For example, the BS can indicate to the NCR that the applicable time length for each beam is 2 slots.

Option 3: explicit indication, where a plurality of time lengths corresponding to the plurality of beams, where each time length is associated with one beam, can be indicated by the BS to the NCR.

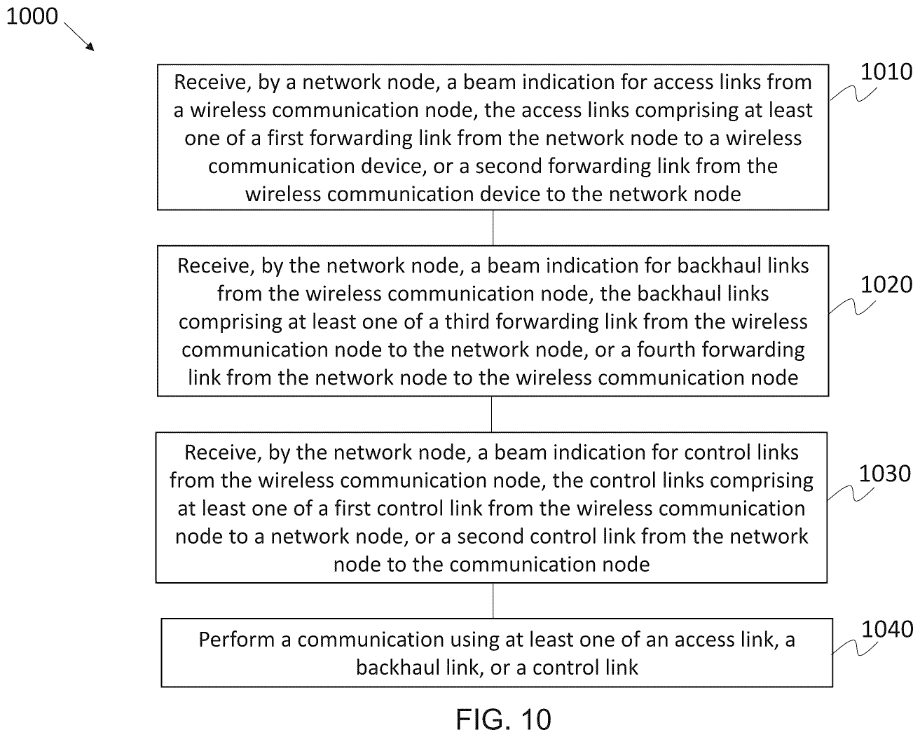

FIG. 10 shows an example of a process for wireless communication based on some example embodiments of the disclosed technology.

In some implementations, the process 1000 for wireless communication may include, at 1010, receiving, by a network node, a beam indication for access links from a wireless communication node, the access links comprising at least one of a first forwarding link from the network node to a wireless communication device, or a second forwarding link from the wireless communication device to the network node. In some implementations, the process 1000 for wireless communication may include, at 1020, receiving, by the network node, a beam indication for backhaul links from the wireless communication node, the backhaul links comprising at least one of a third forwarding link from the wireless communication node to the network node, or a fourth forwarding link from the network node to the wireless communication node. In some implementations, the process 1000 for wireless communication may include, at 1030, receiving, by the network node, a beam indication for control links from the wireless communication node, the control links comprising at least one of a first control link from the wireless communication node to a network node, or a second control link from the network node to the communication node. In one example, the process 1000 includes the operations 1010 and 1020. In another example, the process 1000 includes the operations 1020 and 1030. In another example, the process 1000 includes the operations 1010 and 1030. In one example, the process 1000 includes the operations 1010, 1020, and 1030. In some implementations, the process 1000 for wireless communication may include, at 1040, performing a communication using at least one of an access link, a backhaul link, or a control link. In some implementations, different beam indication mechanisms can be used for different links (e.g., access link, backhaul link, control link). In one example, beam indications for different links are independent of each other.

In some implementations, the network node may be NCR, the wireless communication device may be UE, and the wireless communication node may be BS. In some implementations, the first forwarding link may be the forwarding link 3 from NCR to UE, and the second forwarding link may be the forwarding link 4 from UE to NCR.

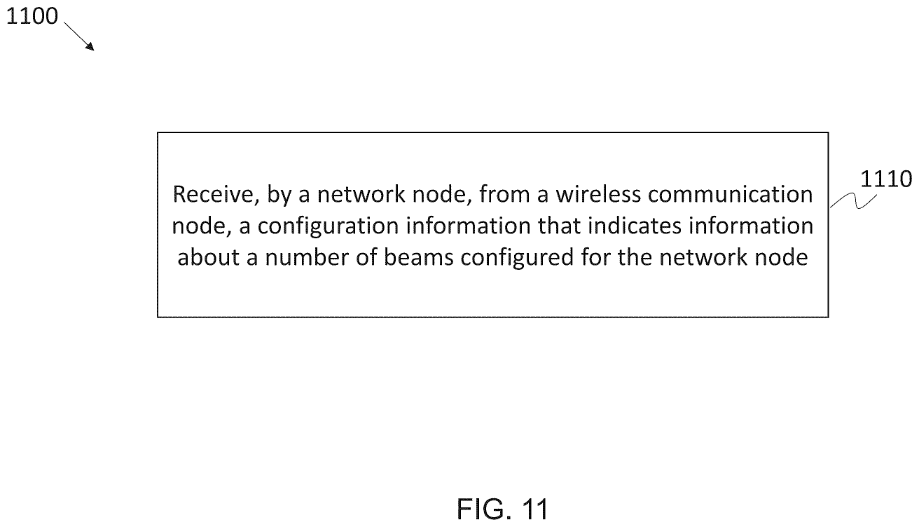

FIG. 11 shows another example of a process for wireless communication based on some example embodiments of the disclosed technology.

In some implementations, the process 1100 for wireless communication may include, at 1110, receiving, by a network node, from a wireless communication node, a configuration information that indicates information associated with a number of beams configured for the network node on access links.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a network node, a beam indication for access links from a wireless communication node, the access links comprising at least one of a first forwarding link from the network node to a wireless communication device, or a second forwarding link from the wireless communication device to the network node; and performing a communication using at least one of the access links.

Clause 2. The method of clause 1, further comprising: receiving, by the network node, a beam indication for backhaul links from the wireless communication node, the backhaul links comprising at least one of a third forwarding link from the wireless communication node to the network node, or a fourth forwarding link from the network node to the wireless communication node; and performing a communication using at least one of the backhaul links.

Clause 3. The method of any of clauses 1-2, further comprising: receiving, by the network node, a beam indication for control links from the wireless communication node, the control links comprising at least one of a first control link from the wireless communication node to a network node, or a second control link from the network node to the communication node; and performing a communication using at least one of the control links.

Clause 4. The method of any of clauses 1-3, wherein the wireless communication node receives the beamforming capability information from the network node or an operations administration and maintenance (OAM) unit.

Clause 5. The method of clause 4, wherein the beamforming capability information includes at least one of: a number of beams available for the network node; indices or identities of beams available for the network node; type of beams available for the network node; widths of beams available for the network node; directions of beams available for the network node; or a location of the network node.

In some implementations, the type of beams can indicate different widths of beams, and/or fixed/adaptive beams.

Clause 6. The method of clause 5, wherein the beamforming capability information is defined with a granularity, wherein the granularity is at least one of: per network node or per link.

In some implementations, the link of “per link” can be at least one of the first forwarding link, the second forwarding link, the third forwarding link, the fourth forwarding link, the first control link, or the second control link.

Clause 7. The method of clause 1, wherein the beam indication for the access links is associated with indices or identities of beams for the network node on the access links.

Clause 8. The method of clause 7, wherein the indices or identities of beams for the network node on the access links are uniformly numbered one by one.

Clause 9. The method of clause 7, wherein widths of beams for the network node on the access links include first widths of beams and second widths of beams, wherein each first width of beam has a wider width than each second width of beam, and wherein each first width of beam includes a group of second widths of beams.

Clause 10. The method of any of clauses 7 and 9, wherein the indices or identities of the first widths of beams are uniformly numbered, the indices or identities of the second widths of beams under the same first width of beams are numbered one by one.

Clause 11. The method of any of clauses 7, 9 and 10, wherein the indices or identities of beams for the network node on the access links are indicated by the wireless communication node to the network node using a single signaling.

Clause 12. The method of clause 11, wherein the single signaling includes multiple bits that include a first set of bits and a second set of bits, wherein the first set of bits indicates the indices or identities of the first widths of beams on the access links and the second set of bits indicates the indices or identities of the second widths of beams on the access links.

Clause 13. The method of any of clauses 7, 9 and 10, wherein the indices or identities of the first widths of beams on the access links are indicated using a first signaling and the indices or identities of the second widths of beams on the access links are indicated using a second signaling.

Clause 14. The method of any of clauses 7 and 9, wherein the indices or identities of the first width of beams are numbered one by one, and the indices or identities of all second width of beams are numbered one by one.

Clause 15. The method of clause 14, wherein the indices or identities of the first width of beams or second width of beams are indicated by the wireless communication node to the network node using a single signaling.

Clause 16. The method of clause 15, wherein the single signaling includes multiple bits that include a first set of bits and a second set of bits, wherein the first set of bits includes a bit to determine whether the indicated beam indices or identities are for the first widths of beams or the second widths of beams, and the second set of bits includes the beam indices or identities of the first width of beams or the second width of beams.

Clause 17. The method of clause 1, wherein the beam indication for the access links for the network node on the access links is associated with a plurality of indices or identities of a set of reference signals.

Clause 18. The method of clause 17, wherein the reference signals include at least one of a channel state information reference signal (CSI-RS), a synchronization signal block (SSB), a demodulation reference signal (DMRS), or a sounding reference signal (SRS).

Clause 19. The method of any of clauses 17-18, wherein the indices or identities of the set of reference signals are one-to-one mapped to a plurality of beams of network nodes on the access links.

Clause 20. The method of clause 19, wherein the mapping relationship between the indices or identities of the set of reference signals and the plurality of beams is indicated to the network node by the wireless communication node.

Clause 21. The method of clause 19, wherein the mapping relationship between the

indices or identities of the set of reference signals and the plurality of beams is configured by the wireless communication node or an OAM unit.

Clause 22. The method of clause 19, wherein the width of beams on the access links of the network node includes two widths, wherein the two widths include the first width of beam and the second width of beam, wherein each first width of beam has a wider width than each second width of beam, and wherein each first width of beam includes a group of second widths of beams.

Clause 23. The method of clause 22, wherein different types of reference signals are mapped to different widths of beams on the access links of the network node, and a quasi co-location (QCL) relationship of the reference signals corresponding to the second width of beam is the reference signal identities (IDs) corresponding to the first width of beam.

Clause 24. The method of clause 2, wherein the beam indication for the backhaul links is associated with indices or identities of beams for the network on the backhaul links.

Clause 25. The method of clause 2, wherein the beam indication for the backhaul links is associated with a plurality of indices or identities of a set of reference signals.

Clause 26. The method of any of clauses 2-3, wherein beam information associated with the backhaul links is identical to the beam information of the control links.

Clause 27. The method of clause 2, wherein the wireless communication node uses an additional signaling dedicated for the backhaul link to indicate beam information.

Clause 28. The method of clause 2, wherein the wireless communication node uses an additional signaling for determining that a transmission configuration indicator (TCI) state is for beam information associated with the backhaul links.

Clause 29. A method of wireless communication, comprising: receiving, by a network node, from a wireless communication node, a configuration information that indicates information associated with a number of beams configured for the network node on access links.

Clause 30. The method of clause 29, wherein the configuration information includes a list of beam patterns, wherein each beam pattern includes an ordered sequence of beam information to be sequentially used by the network node on the access links.

Clause 31. The method of clause 29, wherein the configuration information includes an ordered sequence of beam information to be used sequentially by the network node on access links.

Clause 32. The method of any of clauses 30-31, wherein the beam information is associated with at least one of indices or identities of beams, a source reference signal identity (RS ID), or a TCI state ID.

Clause 33. The method of any of clauses 30-31, wherein a signaling of the configuration information is indicated via at least one of radio resource control (RRC), medium access control-control element (MAC CE), or downlink control information (DCI).

Clause 34. The method of clause 30, wherein all beam patterns in the list are sequentially numbered with indices or identities.

Clause 35. The method of clause 34, wherein the wireless communication node uses the indices or identities of beam pattern to the network node to determine the beam information used by the network node on the access links.

Clause 36. The method of any of clauses 30-31, further comprising determining timing information applicable for the ordered sequence of beam.

Clause 37. The method of clause 36, wherein the timing information associated with the beams based on a default time length is used for each beam in an ordered sequence of beams.

Clause 38. The method of clause 37, wherein the default time length includes at least one of a slot, a symbol, a predefined number of slots, or a predefined number of symbols.

Clause 39. The method of clause 36, wherein the timing information is a time length applicable for all beams in an ordered sequence of beams.

Clause 40. The method of clause 39, wherein a flag is used to determine a granularity of the time length that is a slot or a symbol.

Clause 41. The method of clause 39, wherein the time length is indicated by the wireless communication node to the network node.

Clause 42. The method of clause 36, wherein the timing information includes a plurality of time lengths corresponding to a plurality of beams, wherein each time length is associated with a beam.

Clause 43. The method of clause 42, wherein the plurality of time lengths is indicated by the wireless communication node to the network node.

Clause 44. An apparatus for wireless communication comprising a processor that is configured to carry out the method of any of clauses 1 to 43.

Clause 45. A non-transitory computer readable medium having code stored thereon, the code when executed by a processor, causing the processor to implement a method recited in any of clauses 1 to 43.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few implementations and examples are described and other implementations, enhancements and variations can be made based on what is described and illustrated in this disclosure.

1. A method of wireless communication, comprising:
receiving, by a network node, a beam indication for access links from a wireless communication node, the access links comprising at least one of a first forwarding link from the network node to a wireless communication device, or a second forwarding link from the wireless communication device to the network node;
receiving, by the network node, a beam indication for backhaul links from the wireless communication node, the backhaul links comprising at least one of a third forwarding link from the wireless communication node to the network node, or a fourth forwarding link from the network node to the wireless communication node; and
performing a communication using at least one of the access links or the backhaul links.

2. The method of claim 1, further comprising:
receiving, by the network node, a beam indication for control links from the wireless communication node, the control links comprising at least one of a first control link from the wireless communication node to a network node, or a second control link from the network node to the wireless communication node; and
performing a communication using at least one of the control links.

3. The method of claim 1, wherein the wireless communication node receives beamforming capability information from the network node or an operations administration and maintenance (OAM) unit, wherein the beamforming capability information includes at least one of: a number of beams available for the network node; indices or identities of beams available for the network node; type of beams available for the network node; widths of beams available for the network node; directions of beams available for the network node; or a location of the network node, wherein the beamforming capability information includes at least one of: a number of beams available for the network node; indices or identities of beams available for the network node; type of beams available for the network node; widths of beams available for the network node; directions of beams available for the network node; or a location of the network node, wherein the beamforming capability information is defined with a granularity, wherein the granularity is at least one of: per network node or per link.

4. The method of claim 1, wherein the beam indication for the access links is associated with indices or identities of beams for the network node on the access links.

5. The method of claim 1, wherein the beam indication for the access links for the network node on the access links is associated with a plurality of indices or identities of a set of reference signals.

6. The method of claim 5, wherein the reference signals include at least one of a channel state information reference signal (CSI-RS), a synchronization signal block (SSB), a demodulation reference signal (DMRS), or a sounding reference signal (SRS).

7. The method of claim 1, wherein the beam indication for the backhaul links is associated with indices or identities of beams for the network node on the backhaul links.

8. The method of claim 1, wherein the beam indication for the backhaul links is associated with a plurality of indices or identities of a set of reference signals.

9. The method of claim 1, wherein beam information associated with the backhaul links is identical to beam information of control links.

10. The method of claim 1, wherein the wireless communication node uses an additional signaling dedicated for the backhaul links to indicate beam information.

11. The method of claim 1, wherein the wireless communication node uses an additional signaling for determining that a transmission configuration indicator (TCI) state is for beam information associated with the backhaul links.

12. A method of wireless communication, comprising:
receiving, by a network node, from a wireless communication node, a configuration information that indicates information associated with a number of beams configured for the network node on access links,
wherein the configuration information includes at least one of: a list of beam patterns; or an ordered sequence of beam information to be used sequentially by the network node on access links, wherein each beam pattern includes an ordered sequence of beam information to be sequentially used by the network node on the access links.

13. The method of claim 12, wherein the beam information is associated with at least one of indices or identities of beams, a source reference signal identity (RS ID), or a TCI state ID.

14. The method of claim 12, wherein a signaling of the configuration information is indicated via at least one of radio resource control (RRC), medium access control-control element (MAC CE), or downlink control information (DCI).

15. The method of claim 12, wherein all beam patterns in the list are sequentially numbered with indices or identities.

16. The method of claim 12, further comprising determining timing information applicable for the ordered sequence of beam information.

17. The method of claim 16, wherein the timing information associated with the beams based on a default time length is used for each beam in an ordered sequence of beams.

18. The method of claim 16, wherein the timing information is a time length applicable for all beams in an ordered sequence of beams.

19. The method of claim 16, wherein the timing information includes a plurality of time lengths corresponding to a plurality of beams, wherein each time length is associated with a beam.

20. An apparatus for wireless communication comprising a processor that is configured to carry out a method, comprising:
receiving, by a network node, a beam indication for access links from a wireless communication node, the access links comprising at least one of a first forwarding link from the network node to a wireless communication device, or a second forwarding link from the wireless communication device to the network node;
receiving, by the network node, a beam indication for backhaul links from the wireless communication node, the backhaul links comprising at least one of a third forwarding link from the wireless communication node to the network node, or a fourth forwarding link from the network node to the wireless communication node; and
performing a communication using at least one of the access links or the backhaul links.
